(19) United States
(12) Patent Application Publication
(10) Pub. No.: US 2019/0330015 A1
(43) Pub. Date: Oct. 31, 2019

(54) ELEVATOR SAFETY SYSTEM

(71) Applicant: Otis Elevator Company, Farmington, CT (US)

(72) Inventors: Lindsay Wos, Florence, SC (US); Tarique Faruki, Florence, SC (US)

(21) Appl. No.: 15/966,323

(22) Filed: Apr. 30, 2018

(51) Int. Cl. B66B 5/00; B66B 1/28; B66B 1/34; B66B 9/00

(52) U.S. Cl. CPC B66B 5/0056; B66B 1/28; B66B 1/3407; B66B 2201/34; B66B 1/3461; B66B 9/00; B66B 5/0006

(57) ABSTRACT

According to an aspect, a technique for operating an elevator safety system using pressure-sensitive detection includes detecting a presence in a safety zone of a first elevator of the elevator system, and activating a safety mode of the first elevator based at least in part on the determination. The technique also includes operating the first elevator in the safety mode, and transmitting data of the first elevator to a server.

### BACKGROUND

The present disclosure relates generally to elevator systems, and more specifically to an elevator safety system using pressure-sensitive detection.

In today's environment, elevator systems are provided to efficiently move people and cargo over many floors of various structures. Elevator systems include a range of equipment to operate and control the elevators of the system. The equipment and related components of the elevator system require maintenance to ensure its safety and reliability to its users. The equipment and components can include load bearing members, drive mechanisms, counterweights and more. Access to the areas housing the equipment is limited to authorized personnel and staff and is inspected on periodic intervals.

### BRIEF SUMMARY

According to an embodiment, a method of operating an elevator safety system using pressure-sensitive detection is provided. The method includes detecting a presence in a safety zone of a first elevator of the elevator system, and activating a safety mode of the first elevator based at least in part on the detection. The method also includes operating the first elevator in the safety mode.

In addition to one or more of the features described herein, or as an alternative, further embodiments may include transmitting data associated with the first elevator to a server.

In addition to one or more of the features described herein, or as an alternative, further embodiments may include wherein the safety zone is located in at least one of on top of the first elevator and a pit of the first elevator.

In addition to one or more of the features described herein, or as an alternative, further embodiments may include wherein the safety mode includes reducing a speed of the first elevator based at least in part on the detection.

In addition to one or more of the features described herein, or as an alternative, further embodiments may include wherein the safety mode includes inhibiting the first elevator from traveling on one or more floors based at least in part on the detection.

In addition to one or more of the features described herein, or as an alternative, further embodiments may include responsive to the detection, stopping the operation of the first elevator.

In addition to one or more of the features described herein, or as an alternative, further embodiments may include responsive to the detection, operating the first elevator at normal speed when traveling outside of the safety zone and at a reduced speed upon entering the safety zone.

In addition to one or more of the features described herein, or as an alternative, further embodiments may include operating the first elevator independently of operating a second elevator in the safety mode.

In addition to one or more of the features described herein, or as an alternative, further embodiments may include detecting a presence on a pressure-sensitive mat of the first elevator and operating a second elevator in the safety mode, wherein the safety mode performs at least one of reducing the speed of the second elevator, stopping the second elevator and operating the second elevator at normal speed outside of the safety zone.

In addition to one or more of the features described herein, or as an alternative, further embodiments may include wherein a second elevator is operated at a reduced speed based at least in part on a safety zone of the first elevator.

In addition to one or more of the features described herein, or as an alternative, further embodiments may include wherein the first elevator remains operational when in the safety mode.

According to another embodiment, an elevator safety system using pressure-sensitive detection is provided. The elevator safety system includes one or more elevator cars, and one or more pressure-sensitive mats operable to detect a presence in a safety zone of the one or more elevator cars. The elevator safety system also includes an elevator controller configured to receive a signal from the one or more pressure-sensitive mats, and activate a safety mode based on the detection.

In addition to one or more of the features described herein, or as an alternative, further embodiments may include transmitting data associated with the one or more elevator cars to a server.

In addition to one or more of the features described herein, or as an alternative, further embodiments may include wherein the one or more pressure-sensitive mats are located in at least one of on top of the one or more elevator cars or a pit of the one or more elevators cars.

In addition to one or more of the features described herein, or as an alternative, further embodiments may include wherein the elevator controller is configured to control the one or more elevators cars by at least one of stopping the operation of the one or more elevators and maintaining the operability of the one or more elevator cars when in the safety mode.

In addition to one or more of the features described herein, or as an alternative, further embodiments may include wherein the elevator controller is configured to operate the one or more elevator cars at normal speed when traveling outside of the safety zone, and operate at a reduced speed upon entering the safety zone responsive to the detection.

In addition to one or more of the features described herein, or as an alternative, further embodiments may include wherein the elevator controller is configured to operate a first elevator car of the one or more elevator cars independently of operating a second elevator car of the one or more elevator cars when in the safety mode.

In addition to one or more of the features described herein, or as an alternative, further embodiments may include detecting a presence on one or more pressure-sensitive mats of a first elevator car of the one or more elevator cars and operating a second elevator car of the one or more elevator cars in the safety mode, wherein the safety mode performs at least one of reducing a speed of the second elevator car, stopping the second elevator car and operating the second elevator car at a normal speed outside of the safety zone.

In addition to one or more of the features described herein, or as an alternative, further embodiments may include wherein the elevator controller is configured to operate a second elevator car of the one or more elevator cars at a reduced speed based on a safety zone of a first elevator car of the one or more elevator cars.

In addition to one or more of the features described herein, or as an alternative, further embodiments may include wherein the elevator controller is configured to inhibit the one or more elevators cars from traveling on one or more floors based at least in part on the detection

Technical effects of embodiments of the present disclosure include an elevator pressure-sensitive detection system with pressure sensing technology to improve elevator safety is described herein.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 depicts an elevator safety system in accordance with one or more embodiments;

FIG. 3 depicts a flowchart for operating an elevator safety system in accordance with one or more embodiments;

FIG. 4 depicts another elevator safety system in accordance with one or more embodiments; and

FIG. 5 depicts a flowchart for operating an elevator safety system in accordance with one or more embodiments.

### DETAILED DESCRIPTION

Elevator systems may require periodic maintenance. During maintenance, as the technicians and authorized staff enter the elevator shaft, they may be exposed to the inner workings and mechanisms controlling the elevator. These include moving parts such as counter-weights, steel cables, belts, and the like.

The techniques described herein implement an elevator pressure-sensitive detection scheme and mechanism for enhancing the safety of operators and maintenance technicians while working in an elevator hoistway and/or pit. In one or more embodiments, a pressure-sensitive mat can be placed on top of the elevator car and/or elevator pit, where a detected signal from the pressure-sensitive mat is transmitted to an elevator controller to modify the operation of one or more elevator(s). In one or more embodiments, the elevator system can factor the status of the pressure-sensitive mats of a current elevator car to modify the operation of the neighboring elevator cars. The techniques described herein do not simply open a safety chain of the elevator system. In contrast to conventional elevator safety systems, the elevator is not taken out-of-service but remains operational when in safety mode. In some embodiments, the elevators can be configured to be taken out-of-service when operating in the safety mode.

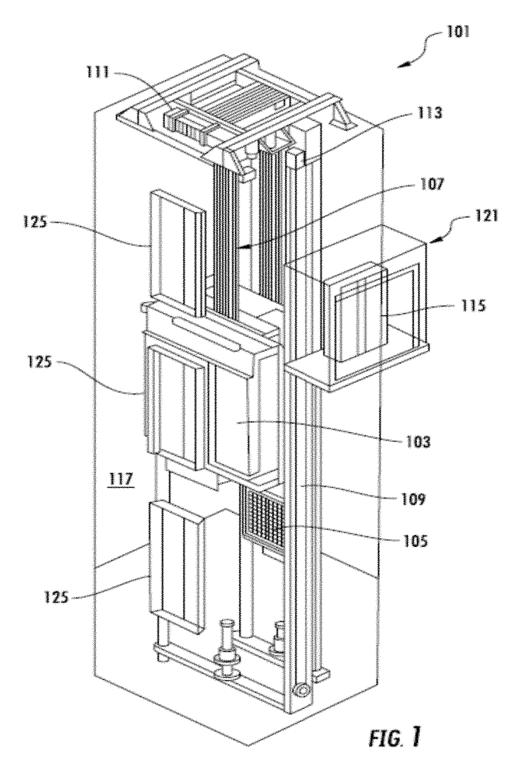

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1.

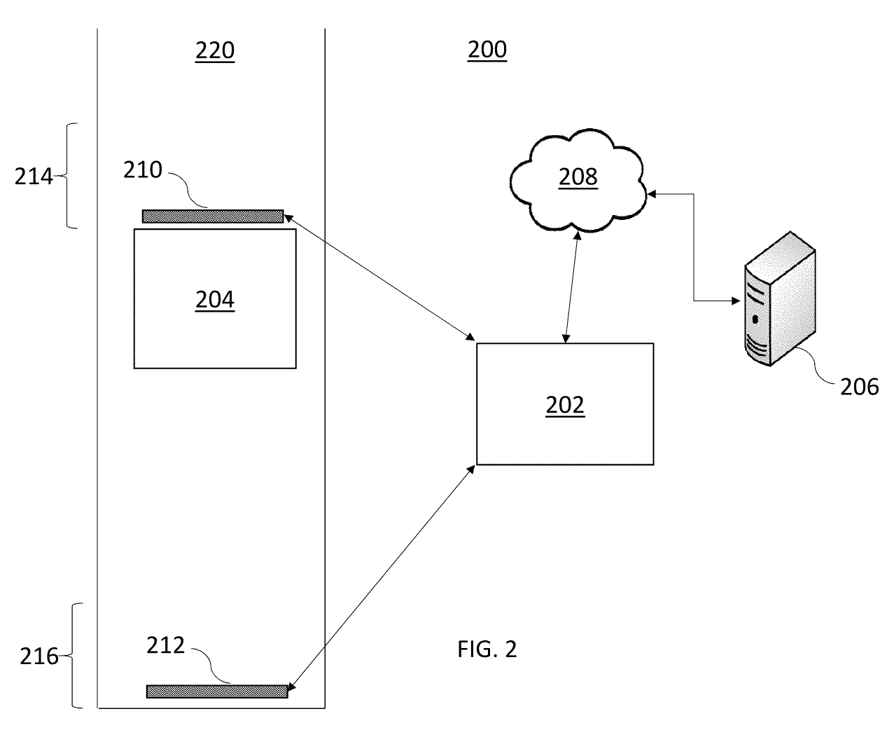

Turning now to a more detailed description of aspects of the present disclosure, FIG. 2 depicts an elevator safety system 200 including pressure-sensitive detection in accordance with one or more embodiments. In one or more embodiments, the elevator system of FIG. 2 can be implemented in the elevator system 101 of FIG. 1.

The elevator safety system 200 includes an elevator controller 202 for controlling the operation of an elevator car 204. The elevator controller 202 can be similar to the elevator controller 115 of FIG. 1. In addition, the elevator controller 202 is configured to communicate by wired/wireless means to a device 206, such as a server or database, over a network 208 and is equipped with the appropriate interfaces for the respective communication.

As shown in FIG. 2, the elevator car 204 is located in a hoistway 220, which is also known as an elevator shaft. In one or more embodiments, a safety zone 214, 216 is a designated area of the hoistway 220 where maintenance personnel will have clearance to work without interference from overhead structures or obstacles. Embodiments include limiting and/or restricting access to the safety zones 214, 216 for the safety of staff or objects present in the safety zone 214, 216. In one or more embodiments, the safety zone 216 can be designated in the elevator pit, at the maximum height of the elevator hoistway 220, and/or a threshold number of floors above and/or below the elevator car. The safety zone 214, 216 can be configured based on the position of the cables, counter-weights, neighboring cars and equipment, or other mechanisms and structures used to operate the elevator 204. In other embodiments, the safety zone 214, 216 can be dynamically reconfigured by the elevator controller 202 from its current configuration based on the collected data or safety metrics to include a smaller/larger number of floors to adjust the buffer space provided to the personnel in the hoistway 220. A smaller threshold number of floors allows the elevator 204 to operate over a wider range when in the safety mode. A larger threshold number of floors allows the staff to have a larger clearance of headspace to work, while limiting the number of floors that are still assessable to the elevator car.

The safety mode as described below reduces the risk of a person unexpectedly physically contacting one or more structures of the elevator system. In a non-limiting example, the safety zone 214 can be located on top of an elevator car 204 where maintenance personnel may be exposed to moving parts such a counter-weights, cables, and the like in the hoist way. In another non-limiting example, the safety zone 216 can be located below the elevator car 204 such as in the elevator pit where maintenance personnel may be at risk of the elevator car 204 as it travels towards the floor of the elevator pit.

In one or more embodiments, the presence of a person or object can be detected in the safety zone 214, 216 by pressure-sensitive mats 210, 212. The pressure-sensitive mats 210, 212 can include one or more pressure sensors that are strategically positioned on the pressure-sensitive mats 210, 212 and are configured to send signals to an elevator controller 202 or other devices 206 for storage and/or processing. In addition, the pressure-sensitive mats 210, 212 can be configured to detect pressures of various weights to trigger the safety mode. For example, the pressure-sensitive mats can be configured to detect and differentiate the weight of small objects and large objects. In a different example, the pressure-sensitive mats can be configured to detect different weights of people and objects. The pressure-sensitive mat having a plurality of pressure sensors can detect the placement of two feet being placed on the mat as indicating a person. In addition, in the case a single point of pressure is detected by the pressure-sensitive mats, it can indicate an object as opposed to a person based on the number of sensors and the weight that has been detect. This information can be used to configure different elevator operation in the safety mode based on the detection of a person and an object.

The pressure mats 210, 212 can be located in various safety zones 214, 216 such as the top of an elevator car 204 or on the floor of an elevator pit. In one or more embodiments, the safety zone 214, 216 of the elevator can be configured to be two or more floors above the elevator pit or two or more floors above the elevator car, or two or more floors from the ceiling of the hoistway. The safety zones 214, 216 can also be configured based on the type of maintenance being performed in the hoistway 220. For example, if the maintenance being performed requires a large range of overhead space, more floors can be restricted from accessing the safety zone. On the other hand, if the work being performed is located immediately above the elevator car 204, two or three floors, as an example, can be restricted and located in the safety zone

When operating in safety mode, the elevator car 204 can maintain its operability with reduced speed and/or with limited access to certain floors overlapping the safety zone. For example, the speed of the elevator car 204 can be reduced responsive to the detection of the presence of a person or object in the safety zone 214, 216. In another embodiment, the elevator car 204 can be stopped prior to approaching the safety zone 214, 216. In another embodiment, the speed of the elevator car 204 can be reduced until a particular floor is reached and then the elevator car 204 is subsequently stopped. In one or more embodiments, a configurable delay can be used when switching the operational mode the elevator 204 from a normal mode to a safety mode to determine if the detected presence has cleared and is no longer an issue. Additionally, the elevator 204, when operating in the safety mode, can maintain its normal speed when traveling outside of the safety zone 214, 216 and reduce its speed while in the safety zone 214, 216. An elevator 204 that is moving away from the safety zone 216 can also be operated at a normal speed while an elevator 204 that is approaching the safety zone 216 is operated at a reduced speed.

In one or more embodiments, when a presence is detected in the safety zone the operability of the elevator 204 is not completely disabled where all power is removed from the elevator 204 when the normal mode is switched to the safety mode, as in elevator systems that use safety chains. Also, unlike breaking a safety chain, the elevator car 204 does not have to be manually reset by maintenance personnel to allow power to the elevator car 204 to resume operation. In other embodiments, the elevator car 204 can be configured to be manually reset to restore power to the particular elevator car 204 to resume normal operation.

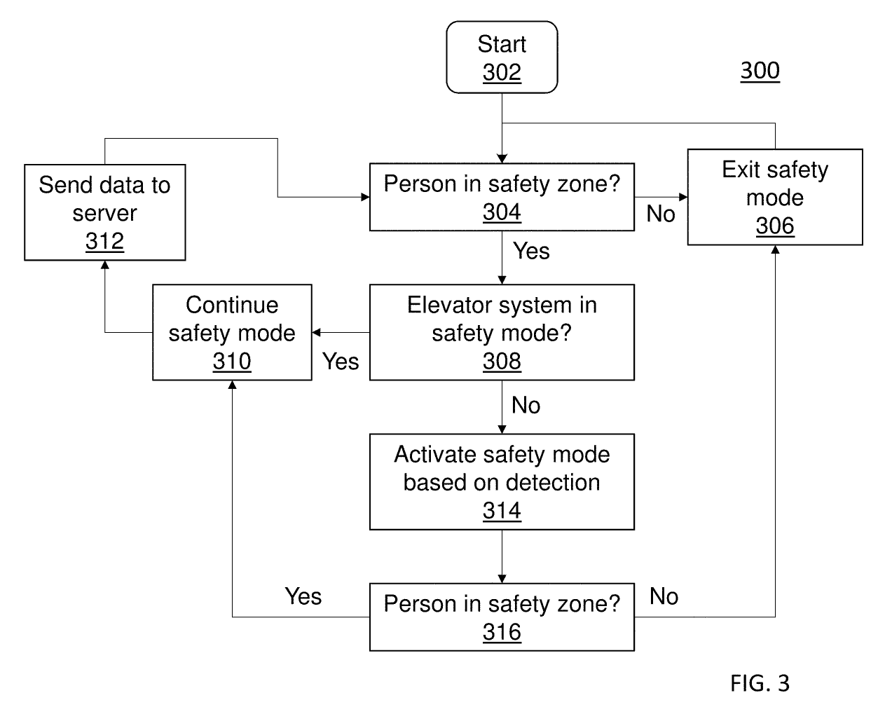

Referring now to FIG. 3, a method 300 for operating an elevator safety system including pressure-sensitive detection in accordance with one or more embodiments is shown. The method 300 begins at block 302 which can be implemented in a system such as the elevator system shown in FIG. 2 and proceeds to block 304 which includes detecting whether a person or the presence of an object is in the safety zone. The detection is based on a signal transmitted from the pressure-sensitive mat coupled to the system. The pressure-sensitive mat is configurable to detect the presence of different objects and is not limited to detecting people. For example, the pressure-sensitive mat can be configured to trigger the safety mode at various weights. As shown in block 304, if a person is not detected the method 300 continues to block 306 where the method 300 exits safety mode or the safety mode is disabled. Next, the method 300 continues to detect the presence of a person or object as shown at block 304.

If it is determined that a presence is detected in the safety zone, the process continues to block 308 to determine whether the elevator system is currently operating in safety mode. If so, the process continues to block 310 to continue operating in the safety mode. As shown in block 312, the data is transmitted to the server. In one or more embodiments, the data can be transmitted either directly or indirectly through the elevator controller to the server. The transmission can be sent over a wired/wireless network. The data sent over the network can include storing pressure information, timing information, movement information, presence information, and so on.

If the elevator system is not currently operating in safety mode at block 308, the method 300 proceeds to block 314 which includes switching the elevator system to the safety mode based on the detection of a presence in the safety zone. Next, the method 300 proceeds to block 316 and includes determining whether the presence of a person or object is still detected in the safety zone. If not, the method 300 proceeds to block 306 and exits the safety mode. In one or more embodiments, after exiting safety mode an update is transmitted to the server. Otherwise, the elevator system continues to operate in the safety mode as shown in block 310 and transmits the data to the server to provide an update as shown in block 312. One or more embodiments include periodically checking for the presence of the presence in the safety zone as shown in block 304. In one or more embodiments, the periodic interval at which the presence is detected is a configurable interval.

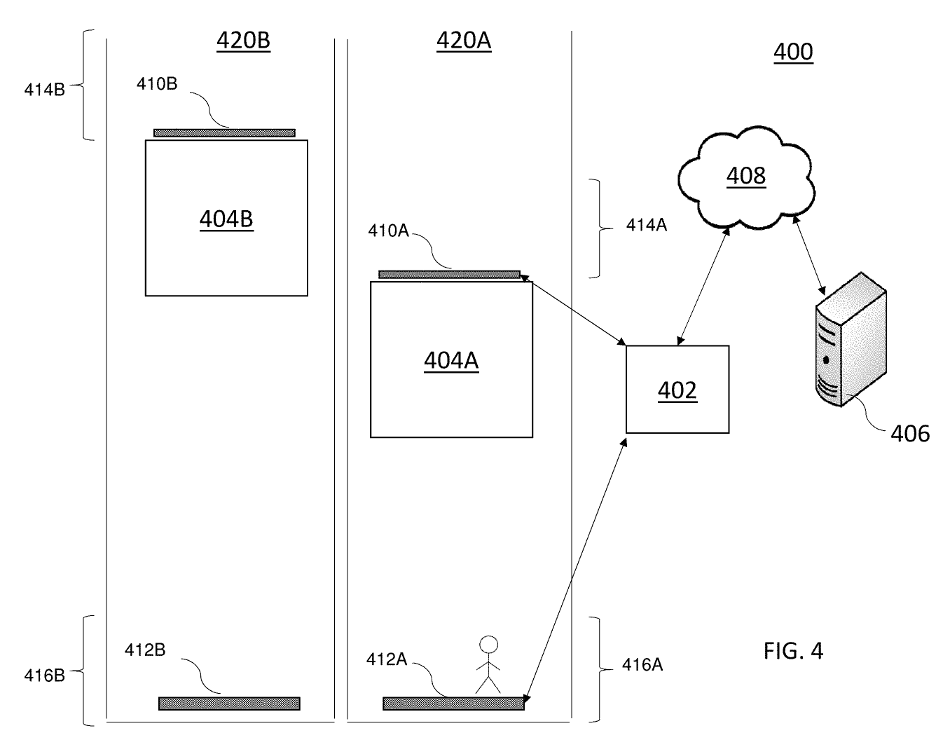

Now referring to FIG. 4, another elevator safety system 400 including pressure-sensitive detection in accordance with one or more embodiments is shown.

FIG. 4 includes an elevator controller 402, elevator car(s) 404 (A, B), server 406, and network 408 similar to that shown in FIG. 2. In addition, FIG. 4 includes a first elevator car 404A in a first hoistway 420A and a second elevator car 404B in a second hoistway 420B having pressure-sensitive mats 410A, 412A and pressure-sensitive mats 410B, 412B, respectively. Each elevator car 404A, 404B has corresponding safety zones 414A, 416A and 414B, 416B. It should be understood that any number and configuration of elevators can be used. The scope of the disclosure is not limited to only the first and second elevators 404A, 404B shown in FIG. 4.

In one or more embodiments, the safety zones 414, 416 can be configured to reduce the speed of the neighboring elevator cars or restrict the access to a number of floors based on an elevator operating in the safety mode.

In one or more embodiments, the detection of the presence in a neighboring or adjacent elevator's safety zone can impact the operation of the current elevator. For example, if a person is detected on the pressure-sensitive mat 412A of the first elevator pit, the operation of the neighboring elevator 404B can switched from normal operational mode to the safety mode. The safety mode can reduce the speed of the elevator 404B or prevent the elevator 404B from access to floors that are within the safety zone 416A of the first elevator 404A. This provides increased safety for the elevator personnel working in the hoistway 420A. In addition, the first elevator 404A can be switched to the safety mode to reduce the speed of the first elevator 404A and prevent the first elevator 404A from accessing floors that are within the safety zone 416A. When the pressure-sensitive mat 412A no longer detects a presence in the elevator pit, the operation of the first and second elevators 404A, 404B can resume in the normal operation. In other embodiments, the elevators 404A, 404B can be configured to operate independently of the neighboring elevator's safety mode status.

In one or more embodiments, the presence information detected at a pressure-sensitive mat 412, 414 is transmitted to the elevator controller 402. The data transmitted to the elevator controller 402 can include but is not limited location information, duration information, weight information, safety mode status, and the like. The elevator controller 402 is configured to transmit data to a network/cloud 408 for further storage and or processing. The elevator controller 402 is also configured to obtain data from the network/cloud 408.

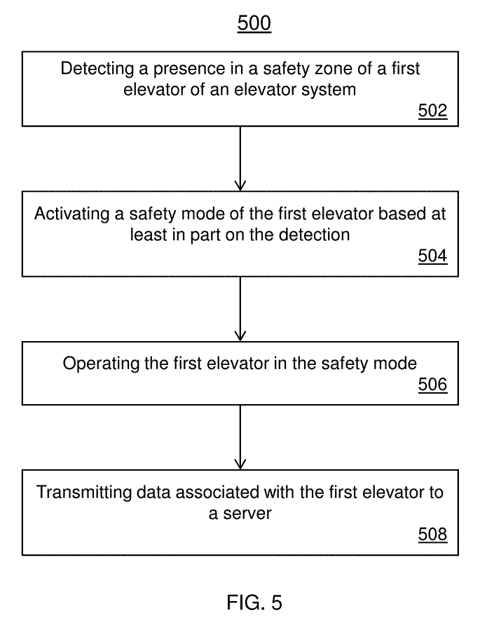

Now referring to FIG. 5, a flow diagram illustrating a method 500 for operating an elevator safety system including pressure-sensitive detection in accordance with one or more embodiments is shown. As shown at block 502, the method 500 includes detecting a presence in a safety zone of a first elevator. The detection is detected by pressure-sensitive mats that are positioned in a location corresponding to the safety zone.

One or more embodiments provide for determining a mode of operation of the first elevator as an optional step. The elevators are configured to operate in a normal mode and a safety mode, and when operating in the safety mode the elevator car speed is reduced and/or limiting a number of floors that are accessible based on a position on the elevator car.

Continuing with reference to FIG. 5, the method 500 also includes activating a safety mode of the first elevator based at least in part on the detection as shown at block 504. In one or more embodiments, the elevator car, responsive to the detection by the pressure-sensitive mat, is switched from the normal mode to the safety mode. Proceeding to block 506, the method 500 includes operating the first elevator in the safety mode. As shown in block 508, the method 500 includes transmitting data associated with the first elevator to a server. In one or more embodiments, the data can be transmitted to the elevator controller, such as elevator controller 402. In other embodiments, the information can be transmitted directly to the server, such as server 406 of FIG. 4. In different embodiments, the information can be transmitted to the elevator controller and then transmitted to the server over a network. The data transmissions can occur over a wired or wireless communication channel.

The technical benefits and effects include maintaining the operations of an elevator car in safety mode. Mechanics are no longer required to reset/restart a safety chain in order to resume operation of an elevator car which can reduce the delay in resuming the operation of the car. The downtime experienced by customers of the elevator system will also be reduced due to the elevator system remaining operational during the safety mode.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of operating an elevator safety system using pressure-sensitive detection, comprising:
detecting a presence in a safety zone of a first elevator of the elevator system;
activating a safety mode of the first elevator based at least in part on the detection; and
operating the first elevator in the safety mode.

2. The method of claim 1, further comprising transmitting data associated with the first elevator to a server.

3. The method of claim 1, wherein the safety zone is located in at least one of on top of the first elevator and a pit of the first elevator.

4. The method of claim 3, wherein the safety mode includes reducing a speed of the first elevator based at least in part on the detection.

5. The method of claim 3, wherein the safety mode includes inhibiting the first elevator from traveling on one or more floors based at least in part on the detection.

6. The method of claim 1, further comprising responsive to the detection, stopping the operation of the first elevator.

7. The method of claim 1, further comprising responsive to the detection, operating the first elevator at normal speed when traveling outside of the safety zone and at a reduced speed upon entering the safety zone.

8. The method of claim 3, further comprising operating the first elevator independently of operating a second elevator in the safety mode.

9. The method of claim 1, further comprising detecting a presence on a pressure-sensitive mat of the first elevator and operating a second elevator in the safety mode, wherein the safety mode performs at least one of reducing the speed of the second elevator, stopping the second elevator and operating the second elevator at normal speed outside of the safety zone.

10. The method of claim 1, wherein a second elevator is operated at a reduced speed based at least in part on a safety zone of the first elevator.

11. The method of claim 10, wherein the first elevator remains operational when in the safety mode.

12. An elevator safety system comprising:
one or more elevator cars;
one or more pressure-sensitive mats operable to detect a presence in a safety zone of the one or more elevator cars; and
an elevator controller configured to receive a signal from the one or more pressure-sensitive mats, and activate a safety mode based on the detection.

13. The elevator system of claim 12, further comprising transmitting data associated with the one or more elevator cars to a server.

14. The elevator system of claim 12, wherein the one or more pressure-sensitive mats are located in at least one of on top of the one or more elevator cars or a pit of the one or more elevators cars.

15. The elevator system of claim 14, wherein the elevator controller is configured to control the one or more elevators cars by at least one of stopping the operation of the one or more elevators and maintaining the operability of the one or more elevator cars when in the safety mode.

16. The elevator system of claim 14, wherein the elevator controller is configured to operate the one or more elevator cars at normal speed when traveling outside of the safety zone, and operate at a reduced speed upon entering the safety zone responsive to the detection.

17. The elevator system of claim 15, wherein the elevator controller is configured to operate a first elevator car of the one or more elevator cars independently of operating a second elevator car of the one or more elevator cars when in the safety mode.

18. The elevator system of claim 12, further comprising detecting a presence on one or more pressure-sensitive mats of a first elevator car of the one or more elevator cars and operating a second elevator car of the one or more elevator cars in the safety mode, wherein the safety mode performs at least one of reducing a speed of the second elevator car, stopping the second elevator car and operating the second elevator car at a normal speed outside of the safety zone.

19. The elevator system of claim 15, wherein the elevator controller is configured to operate a second elevator car of the one or more elevator cars at a reduced speed based on a safety zone of a first elevator car of the one or more elevator cars.

20. The elevator system of claim 15, wherein the elevator controller is configured to inhibit the one or more elevators cars from traveling on one or more floors based at least in part on the detection.
